(19) United States
(12) Patent Application Publication
(10) Pub. No.: US 2023/0023750 A1
(43) Pub. Date: Jan. 26, 2023

(54) METHOD FOR THE MEDIA-TIGHT CONNECTION OF TWO PLATE-SHAPED COMPONENTS

(71) Applicant: Robert Bosch GmbH, Stuttgart (DE)

(72) Inventors: Axel Bormann, Bamberg (DE); Johannes Hagen, Stegaurach (DE); Thorsten Laube, Hirschaid (DE)

(21) Appl. No.: 17/871,038

(22) Filed: Jul. 22, 2022

(30) Foreign Application Priority Data
Jul. 22, 2021 (DE) 102021207884.2

(51) Int. Cl. B23K 26/26; H01M 8/0247; H01M 8/0206

(52) U.S. Cl. CPC B23K 26/26; H01M 8/0247; H01M 8/0206

(57) ABSTRACT

The invention relates to a method for the media-tight connection of two plate-shaped components (1, 2), in particular two monopolar plates for the production of a bipolar plate, comprising the steps of:
placing the first component (1) on a surface of a clamping device,
placing the second component (2) on the first component (1),
closing the clamping device,
setting a first weld seam (3) on the second component (2), wherein a welding depth (t) is selected that is less than a material thickness (s) of the second component (2), with the result that a bend (5) is formed along the first weld seam (3) owing to the welding distortion, via which bend the second component (2) comes into linear contact with the first component (1),
setting a connecting weld seam (4) on the first weld seam (3), with the result that the two components (1, 2) are welded to one another along the bend (5).

### BACKGROUND OF THE INVENTION

The present invention relates to a method for the media-tight connection of two plate-shaped components, in particular for the media-tight connection of two monopolar plates to produce a bipolar plate for a fuel cell stack.

In a fuel cell stack, bipolar plates separate the individual fuel cells. The bipolar plates generally comprise two monopolar plates which are welded together. The monopolar plates are thin, embossed metal sheets which, when placed on top of one another and connected to one another, jointly enclose a cavity. Since a cooling medium is subsequently supplied to the cavity during operation of the fuel cell stack, the two monopolar plates must be connected to one another in a media-tight manner. They are therefore usually welded together. Laser welding is used here in particular.

In the media-tight welding of the two monopolar plates by means of a laser beam, the two metal sheets, which are generally only 50 to 100 μm thick, must be brought into contact over the entire length of the weld seam, which can be several meters. In this case, it is necessary to achieve technical zero gaps, which must be no more than 20 μm in size. For this purpose, high-precision clamping tools as well as multi-part hold-down devices are used. This results in high costs for the tools and long cycle times of the laser welding machine since the process is generally multi-stage. In order to achieve technical zero gaps, the entire surface must be kept free of microparticles, so that the required technical cleanliness entails further costs.

In the media-tight welding of the two monopolar plates, welding errors can therefore easily occur. For example, instead of one weld seam connecting the two metal sheets, two weld seams may be formed, namely one weld seam per metal sheet. In this case, the second weld seam arises from the excess laser power which emerges at the root of the first weld seam. The two sheets are then not connected to one another in this region, and therefore comparatively large gaps remain between these sheets. In this case, the bipolar plates are not media-tight.

### SUMMARY OF THE INVENTION

The present invention attempts to remedy this situation. In particular, when sealingly welding two thin metal sheets, such as, for example, two monopolar plates, the formation of a weld seam continuously connecting the metal sheets is to be simplified.

The proposed method for the media-tight connection of two plate-shaped components, in particular two monopolar plates for the production of a bipolar plate, comprises the steps of:

placing the first component on a surface of a clamping device,

placing the second component on the first component,

closing the clamping device,

setting a first weld seam on the second component, wherein a welding depth t is selected that is less than a material thickness s of the second component, with the result that a bend is formed along the first weld seam owing to the welding distortion, via which bend the second component comes into linear contact with the first component,

setting a connecting weld seam on the first weld seam, with the result that the two components are welded to one another along the bend.

In the proposed method, two weld seams are placed one on top of the other, with only the second weld seam serving to connect the two components. With the aid of the first weld seam, it is only a deformation of the second component that is to be achieved, ensuring linear contact between the second component and the first component, to be precise exactly in the region of the later connecting weld seam. Flat contact between the two components is accordingly not important, and therefore a comparatively simple and less massive clamping device can be used for clamping the two components. In particular, multiple reclamping and/or changing of hold-down plates, which are/is usually supposed to ensure flat contact between the two components, can be dispensed with. That is to say that there is no need for multiple clamping and unclamping of the components, and the two components remain optimally aligned with one another. At the same time, the cycle time for the connection of the two components is significantly reduced. This is because the additional cycle time required for setting the first weld seam is virtually negligible.

With the aid of the clamping device, the two components to be connected are preferably only locally spring-loaded, thus ensuring they are fixed in their position with respect to one another. The contact between the two components can be limited to the linear contact along the bend. This ensures that the second component rests against the first component in this region.

A welding depth t of 20 to 80%, preferably 30 to 70%, as a further preference 40 to 60%, of the material thickness s of the second component is preferably selected when setting the first weld seam. As a particular preference, the welding depth is half of the second component, that is to say the welding depth t is 50% of the material thickness s.

Setting the first weld seam leads to severe heating of the second component on its upper side, while the underside is subject to minimal heating, if any. As a result of the different temperature distribution and as a result of conversion of the material of the second component in the region of the first weld seam, welding distortion occurs. The welding distortion leads to the formation in the second component of the bend via which the latter is preloaded against the first component, resulting in linear contact.

As a further preference, a metal sheet having a sheet metal thickness or material thickness s of from 50 to 100 μm is used for each of the two components. That is to say that very thin metal sheets are preferably used. This applies particularly if the method is used to connect two monopolar plates to produce a bipolar plate. The thinner the material, the greater the deformation when the first weld seam is set on the second component or sheet. That is to say that a significant bend is formed which brings about the desired linear contact.

It is advantageous if the same tool, preferably a laser welding machine, is used for setting the first weld seam and the connecting weld seam. Producing both weld seams with the same tool ensures that the second weld seam or connecting weld seam is seated exactly on the first weld seam. When a laser welding machine is used as a tool, it is possible to set weld seams with different welding depths t via the power of the laser welding machine and/or other operating parameters that affect the laser beam used for welding.

In order to prevent through-welding when setting the first weld seam, it is proposed that a laser beam is moved over the second component at a rate of at least 0.5 m/s when setting the first weld seam. At the same time, it is possible in this way to set the first weld seam quickly.

For reasons of saving time, it is further proposed that a plurality of first weld seams be set simultaneously. This is preferably carried out by means of a plurality of laser beams which are moved simultaneously over the second component at different points. In this way, it is possible to recoup the additional cycle time required for setting the first weld seam. The same can apply analogously to the setting of the second weld seam or connecting weld seam, thus enabling the cycle time to be further shortened.

As a development of the invention, it is proposed that, before the connecting weld seam is set, the second component is secured on the first component, for example by means of tacking. For this purpose, different tacking points can be set, it being possible to use the same tool as that used for setting the weld seams. The additional method step of tacking counteracts any axial distortion of the second component during the setting of the second weld seam or connecting weld seam. This ensures that the linear contact between the two components along the bend is maintained.

It is furthermore proposed that a clamping device with clamping jaws is used for the local spring-loading of the two components. As a result, time-consuming reclamping of hold-down plates is eliminated.

### BRIEF DESCRIPTION OF THE DRAWINGS

The invention and its advantages are explained in greater detail below with reference to the attached drawings. More specifically:

FIG. 1 shows a schematic longitudinal section through two plate-shaped components to be connected, and

FIG. 2 shows a schematic longitudinal section through the two components of FIG. 1 after connection.

### DETAILED DESCRIPTION

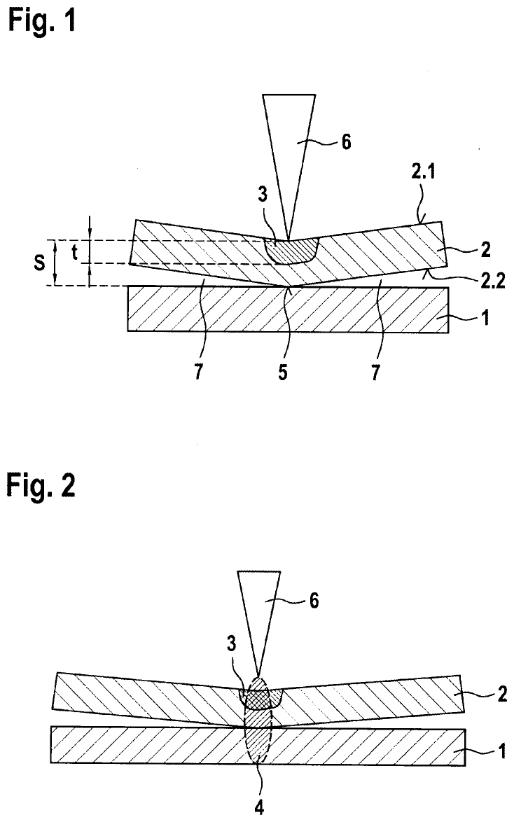

FIG. 1 shows, by way of example, two plate-shaped components 1, 2 lying one on top of the other, it being possible, in particular, for these to be two thin metal sheets, for example two monopolar plates, for the production of a bipolar plate.

For the media-tight connection of the two components 1, 2, the first component 1 is first placed on a surface of a clamping device (not illustrated). The second component 2 is then placed on the first component 1, with the result that the two components 1, 2 lie flat against one another. The two components 1, 2 are then clamped by closing the clamping device, and their position with respect to one another is thus fixed. A comparatively simple clamping device can be used for fixing.

A first weld seam 3 is then set on an upper side 2.1 of the second component 2 with the aid of a laser beam 6 of a laser welding machine (not illustrated). The welding depth t of the first weld seam 3 is approximately half the material thickness s of the second component 2 in the region of the weld seam 3. This means that component 2 heats up more on its upper side 2.1 than on its lower side 2.2. As a result of the welding distortion, a bend 5 is formed, along which the second component 2 comes into linear contact with the first component 1. To the left and right of the bend there are wedge-shaped gaps 7, which are not only tolerated but are also desirable since they are used for degassing.

After the first weld seam 3 has been set and the bend 5 has been formed, a second weld seam is set as a connecting weld seam 4, preferably with the same tool and without prior reclamping of the clamping device, to be precise exactly on the first weld seam 3, with the result that the two components 1, 2 are welded to one another along the bend 5. The linear contact between the two components 1, 2 in this region contributes to the fact that the connecting weld seam 4 has no defects and is thus media-tight.

1. A method for the media-tight connection of first and second plate-shaped components (1, 2) the method comprising the steps of:
placing the first component (1) on a surface of a clamping device,
placing the second component (2) on the first component (1),
closing the clamping device,
setting a first weld seam (3) on the second component (2), wherein a welding depth (t) is selected that is less than a material thickness (s) of the second component (2), with the result that a bend (5) is formed along the first weld seam (3) owing to the welding distortion, via which bend the second component (2) comes into linear contact with the first component (1), and
setting a connecting weld seam (4) on the first weld seam (3), with the result that the two components (1, 2) are welded to one another along the bend (5).

2. The method according to claim 1, wherein a welding depth (t) of 20 to 80% of the material thickness (s) of the second component (2) is selected when setting the first weld seam (3).

3. The method according to claim 1, wherein a metal sheet having a sheet metal thickness or material thickness (s) of from 50 to 100 μm is used for each of the two components (1, 2).

4. The method according to claim 1, wherein the same tool is used for setting the first weld seam (3) and the connecting weld seam (4).

5. The method according to claim 1, wherein a laser beam (6) is moved over the second component (2) at a rate of at least 0.5 m/s when setting the first weld seam (3).

6. The method according to claim 1, wherein a plurality of first weld seams (3) is set simultaneously.

7. The method according to claim 1, wherein, before the connecting weld seam (4) is set, the second component (2) is secured on the first component (1).

8. The method according to claim 1, wherein a clamping device with clamping jaws is used for the local spring-loading of the two components (1, 2).

9. A method for the media-tight connection of first and second monopolar plates for the production of a bipolar plate, the method comprising the steps of:
placing the first component (1) on a surface of a clamping device,
placing the second component (2) on the first component (1),
closing the clamping device,
setting a first weld seam (3) on the second component (2), wherein a welding depth (t) is selected that is less than a material thickness (s) of the second component (2), with the result that a bend (5) is formed along the first weld seam (3) owing to the welding distortion, via which bend the second component (2) comes into linear contact with the first component (1), and
setting a connecting weld seam (4) on the first weld seam (3), with the result that the two components (1, 2) are welded to one another along the bend (5).

10. The method according to claim 9, wherein a welding depth (t) of 30 to 70% of the material thickness (s) of the second component (2) is selected when setting the first weld seam (3).

11. The method according to claim 9, wherein a welding depth (t) of 40 to 60% of the material thickness (s) of the second component (2) is selected when setting the first weld seam (3).

12. The method according to claim 9, wherein a metal sheet having a sheet metal thickness or material thickness (s) of from 50 to 100 μm is used for each of the two components (1, 2).

13. The method according to claim 9, wherein the same laser welding machine is used for setting the first weld seam (3) and the connecting weld seam (4).

14. The method according to claim 9, wherein a laser beam (6) is moved over the second component (2) at a rate of at least 0.5 m/s when setting the first weld seam (3).

15. The method according to claim 9, wherein a plurality of first weld seams (3) is set simultaneously by means of a plurality of laser beams (6).

16. The method according to claim 9, wherein, before the connecting weld seam (4) is set, the second component (2) is secured on the first component (1).

17. The method according to claim 9, wherein, before the connecting weld seam (4) is set, the second component (2) is secured on the first component (1) by means of tacking.

18. The method according to claim 1, wherein a clamping device with clamping jaws is used for the local spring-loading of the two components (1, 2).
